(19) United States
(12) Patent Application Publication
(10) Pub. No.: US 2023/0407762 A1
(43) Pub. Date: Dec. 21, 2023

(54) DAMPERS FOR SEAL ASSEMBLIES

(71) Applicant: General Electric Company, Schenectady, NY (US)

(72) Inventors: Mark L. Hopper, Evendale, OH (US); Scott Francis Wolfer, Evendale, OH (US); Ravindra Shankar Ganiger, Bengaluru (IN)

(73) Assignee: General Electric Company, Schenectady, NY (US)

(21) Appl. No.: 18/207,079

(22) Filed: Jun. 7, 2023

(30) Foreign Application Priority Data
Jun. 15, 2022 (IN) 202211034236

(51) Int. Cl. F01D 25/04; F01D 11/02; F03G 7/06; F01D 25/24

(52) U.S. Cl. CPC F01D 25/04; F01D 11/02; F03G 7/0614; F01D 25/24; F05D 2240/55; F05D 2260/96

(57) ABSTRACT

This disclosure is directed to seal assemblies for a turbomachine. The seal assemblies include stationary and rotating components and at least one interface between the stationary and rotating components. In some examples, seal assembly includes a runner coupled to a rotating shaft and a sealing element coupled to a stationary engine housing. The seal assembly can also include a spring element located between the sealing element and the stationary engine housing, which allows the relative position between the runner and the sealing element to be adjusted while the turbomachine engine is in operation. Some seal assemblies include damping elements positioned between the sealing element and the fixed engine housing to slow the motion of the sealing element relative to the runner to reduce the risk of inadvertent contact between the runner and the sealing element.

### CROSS REFERENCE TO RELATED APPLICATION

This application claims the benefit of India Patent Application No. 202211034236, filed on Jun. 15, 2022, which is incorporated by reference herein in its entirety.

### FIELD

The present disclosure relates to turbomachine engine seals, mechanisms for controlling turbomachine engine seal gaps, and dampers for seal gap control mechanisms.

### BACKGROUND

Turbomachines typically include a rotor assembly, a compressor, and a turbine. The rotor assembly may include a fan having an array of fan blades extending radially outwardly from a rotating shaft. The rotating shaft, which transfers power and rotary motion from the turbine to both the compressor and the rotor assembly, is supported longitudinally using a plurality of bearing assemblies. Known bearing assemblies include one or more rolling elements supported within a paired race. To maintain a rotor critical speed margin, the rotor assembly is typically supported on three bearing assemblies: one thrust bearing assembly and two roller bearing assemblies. The thrust bearing assembly supports the rotor shaft and minimizes axial and radial movement thereof, while the roller bearing assemblies support radial movement of the rotor shaft.

Typically, these bearing assemblies are enclosed within a housing disposed radially around the bearing assembly. The housing forms a compartment or sump that holds a lubricant (e.g., oil) for lubricating the bearing. This lubricant may also lubricate gears and other seals. Gaps between the housing and the rotor shaft are necessary to permit rotation of the rotor shaft relative to the housing. The bearing sealing system usually includes two such gaps: one on the upstream end and another on the downstream end. In this respect, a seal disposed in each gap prevents the lubricant from escaping the compartment. Further, the air around the sump may generally be at a higher pressure than the sump to reduce the amount of lubricant that leaks from the sump. Further, one or more gaps and corresponding seals are generally positioned upstream and/or downstream of the sump to create the higher pressure region surrounding the sump. In some turbomachine engines, the seals may be hydrodynamic or non-contacting seals. To avoid wear of the components of such seals when the turbomachine engines are operational, it is important that no unintentional contact between adjacent components occurs. To accomplish this, various seal gap control mechanisms exist to maintain a desired spacing between non-contacting portions of a non-contacting seal.

### BRIEF DESCRIPTION OF THE DRAWINGS

FIG. 1 illustrates a schematic side view of an example turbomachine engine.

FIG. 2 illustrates a schematic side view of a section of a turbomachine engine including an example of a seal assembly.

FIG. 3A illustrates an enlarged view of the seal assembly depicted in FIG. 2.

FIG. 3B illustrates a schematic side view of a section of a turbomachine engine including a contact seal assembly.

FIG. 4 illustrates a schematic view of a seal assembly according to another example.

FIG. 5 is a cutaway perspective view of a damping mechanism for a non-contacting seal assembly according to one example.

FIG. 6 is a schematic diagram of a seal assembly including a damping mechanism according to another example.

FIG. 7 is a schematic diagram of a seal assembly including a damping mechanism according to another example.

FIG. 8 is a side elevation view of a foil damper according to one example.

FIG. 9 is a schematic illustration of a wave spring damper according to one example.

FIG. 10 is a schematic illustration of a seal assembly and portions of a fixed housing including a vibration damper according to one example.

### DETAILED DESCRIPTION

Reference now will be made in detail to preferred embodiments, one or more examples of which are illustrated in the drawings. Each example is provided by way of explanation, not limitation of the preferred embodiments. In fact, it will be apparent to those skilled in the art that various modifications and variations can be made in the embodiments discussed without departing from the scope or spirit of disclosure. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

As used herein, the terms “first” and “second” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Disclosed herein are examples of turbomachines and seal assemblies for use with turbomachines. The turbomachine may include a rotating shaft extending along a centerline axis and a fixed housing positioned exterior to the rotating shaft in a radial direction relative to the centerline axis. The seal assembly may include a sump housing at least partially defining a bearing compartment for holding a cooling lubricant. The seal assembly may further include a bearing supporting the rotating shaft. In addition, the seal assembly may also include a sump seal at least partially defining the bearing compartment. A pressurized housing of the seal assembly may be positioned exterior to the sump housing and define a pressurized compartment to at least partially enclose the sump housing. Further, a seal may be positioned between the rotating shaft and the pressurized housing to at least partially define the pressurized compartment to enclose the sump housing.

In certain examples, a seal assembly including a self-lubricating lattice material may allow for a more efficient turbomachine. A self-lubricating lattice material disposed between the rotating portions of a seal assembly and the static portions of the seal assembly can reduce the wear of the various seal assembly components that are in rotating contact with one another when the turbomachine is in an operational condition. Additionally, the use of a self-lubricating lattice material can mitigate heat buildup along the operational seal interface. In some examples, the self-lubricating lattice can be permeated with a lubricant and/or a coolant. For example, a self-lubricating lattice material can be deposited between a rotating runner and a static sealing element so as to form a lubricant layer between the runner and the sealing element when the turbomachine engine is operational.

It should be appreciated that, although the present subject matter will generally be described herein with reference to a gas turbine engine, the disclosed systems and methods may generally be used on bearings and/or seals within any suitable type of turbine engine, including aircraft-based turbine engines, land-based turbine engines, and/or steam turbine engines. Further, though the present subject matter is generally described in reference to a high-pressure spool of a turbine engine, it should also be appreciated that the disclosed system and method can be used on any spool within a turbine engine, e.g., a low-pressure spool or an intermediate pressure spool.

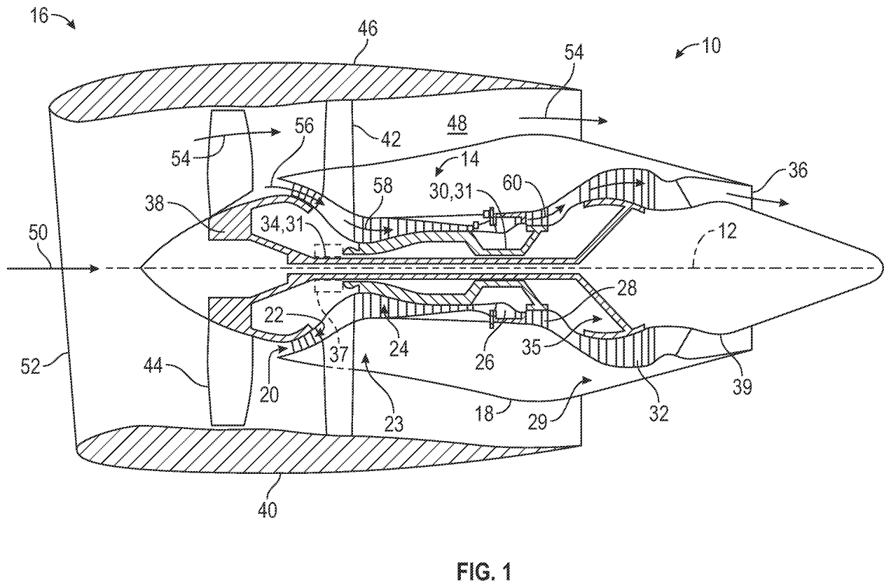

Referring now to the drawings, FIG. 1 illustrates a cross-sectional view of one example of a turbomachine 10, also referred to herein as turbomachine engine 10. More particularly, FIG. 1 depicts the turbomachine 10 configured as a gas turbine engine that may be utilized within an aircraft in accordance with aspects of the present subject matter. The gas turbine engine is shown having a longitudinal or centerline axis 12, also referred to herein as a centerline, extending therethrough for reference purposes. In general, the engine may include a core engine 14 and a fan section 16 positioned upstream thereof. The core engine 14 may generally include a substantially tubular external housing 18 that defines an annular inlet 20. In addition, the external housing 18 may further enclose and support a compressor section 23. For the example show, the compressor section 23 includes a booster compressor 22 and a high-pressure compressor 24. The booster compressor 22 generally increases the pressure of the air (indicated by arrow 54) that enters the core engine 14 to a first pressure level. The high-pressure compressor 24, such as a multi-stage, axial-flow compressor, may then receive the pressurized air (indicated by arrow 58) from the booster compressor 22 and further increases the pressure of such air. The pressurized air exiting the high-pressure compressor 24 may then flow to a combustor 26 within which fuel is injected into the flow of pressurized air, with the resulting mixture being combusted within the combustor 26.

For the example illustrated, the external housing 18 may further enclose and support a turbine section 29. Further, for the depicted example, the turbine section 29 includes a first, high-pressure turbine 28 and second, low-pressure turbine 32. For the illustrated examples, one or more of the compressors 22, 24 may be drivingly coupled to one or more of the turbines 28, 32 via a rotating shaft 31 extending along the centerline axis 12. For example, high energy combustion products 60 are directed from the combustor 26 along the hot gas path of the engine to the high-pressure turbine 28 for driving the high-pressure compressor 24 via a first, high-pressure drive shaft 30. Subsequently, the combustion products 60 may be directed to the low-pressure turbine 32 for driving the booster compressor 22 and fan section 16 via a second, low-pressure drive shaft 34 generally coaxial with high-pressure drive shaft 30. After driving each of turbines 28 and 32, the combustion products 60 may be expelled from the core engine 14 via an exhaust nozzle 36 to provide propulsive jet thrust. Further, the rotating shaft(s) 31 may be enclosed by a fixed housing 39 extending along the centerline axis 12 and positioned exterior to the rotating shaft 31 in a radial direction relative to the centerline axis 12.

Additionally, as shown in FIG. 1, the fan section 16 of the engine may generally include a rotatable, axial-flow fan rotor assembly 38 surrounded by an annular fan casing 40. It should be appreciated by those of ordinary skill in the art that the fan casing 40 may be supported relative to the core engine 14 by a plurality of substantially radially-extending, circumferentially-spaced outlet guide vanes 42. As such, the fan casing 40 may enclose the fan rotor assembly 38 and its corresponding fan blades 44. Moreover, a downstream section 46 of the fan casing 40 may extend over an outer portion of the core engine 14 so as to define a secondary, or bypass, airflow conduit 48 providing additional propulsive jet thrust.

It should be appreciated that, in several examples, the low-pressure drive shaft 34 may be directly coupled to the fan rotor assembly 38 to provide a direct-drive configuration. Alternatively, the low-pressure drive shaft 34 may be coupled to the fan rotor assembly 38 via a speed reduction device 37 (e.g., a reduction gear or gearbox or a transmission) to provide an indirect-drive or geared drive configuration. Such a speed reduction device(s) 37 may also be provided between any other suitable shafts and/or spools within the turbomachine engine 10 as desired or required.

During operation of the turbomachine engine 10, it should be appreciated that an initial airflow (indicated in FIG. 1 by arrow 50) may enter the turbomachine engine 10 through an associated inlet 52 of the fan casing 40. For the illustrated example, the airflow then passes through the fan blades 44 and splits into a first compressed airflow (indicated by arrow 54) that moves through the bypass airflow conduit 48 and a second compressed airflow (indicated by arrow 56) which enters the booster compressor 22. In the depicted example, the pressure of the second compressed airflow 56 is then increased and enters the high-pressure compressor 24 (as indicated by arrow 58). After mixing with fuel and being combusted within the combustor 26, the combustion products 60 may exit the combustor 26 and flow through the high-pressure turbine 28. Thereafter, for the shown example, the combustion products 60 flow through the low-pressure turbine 32 and exit the exhaust nozzle 36 to provide thrust for the engine.

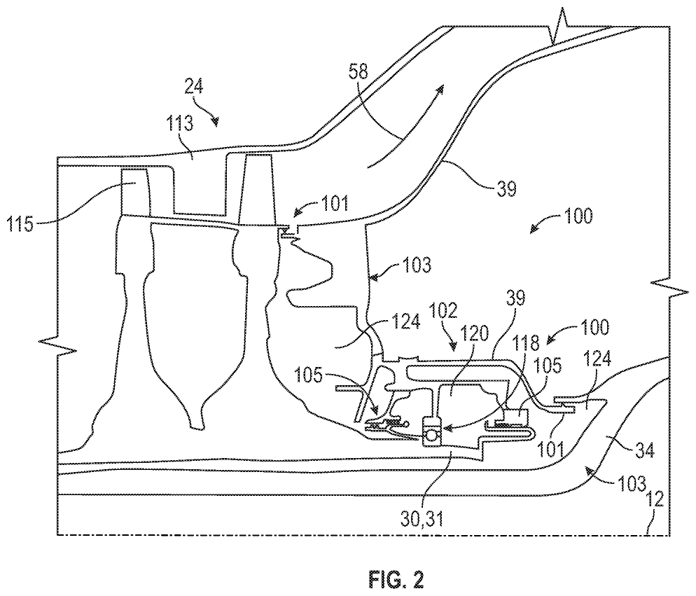

Turning now to FIG. 2, the turbomachine engine 10 can include a seal assembly 100, positioned between stationary and rotating components of the turbomachine engine. For example, the seal assembly 100 can be positioned between the stationary and rotating components of the high-pressure compressor 24 described above.

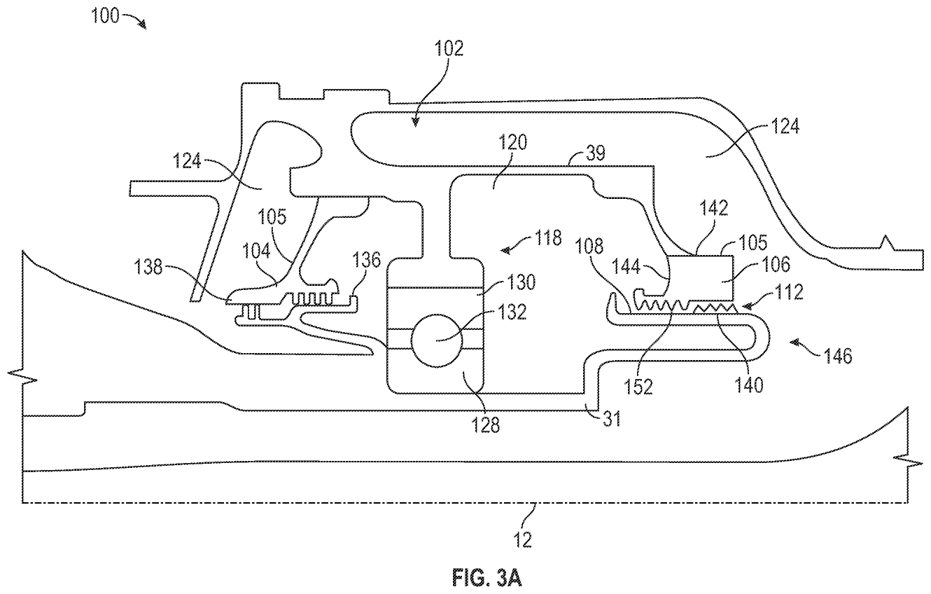

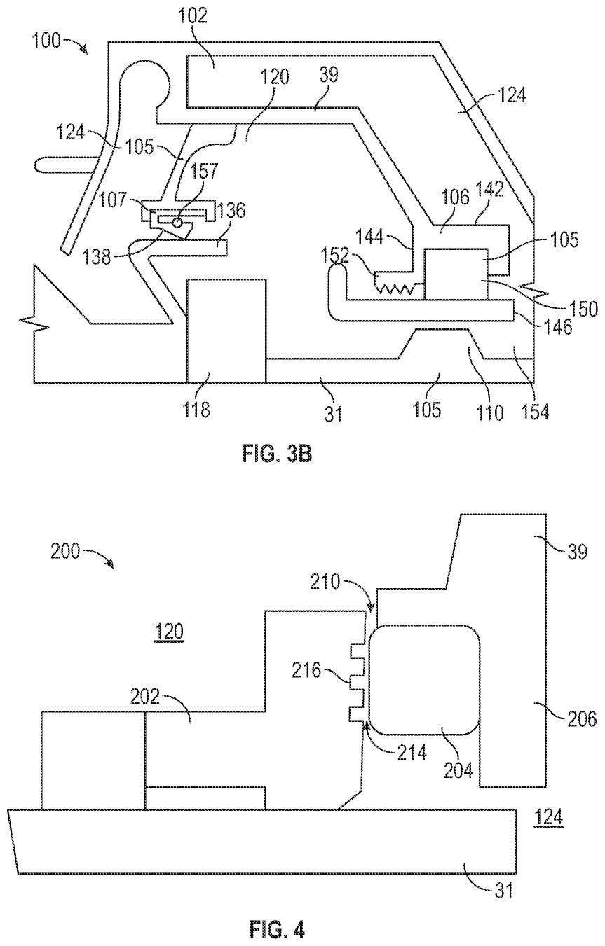

The seal assembly 100 may generally isolate a sump housing 102 from the rest of the turbomachine engine 10. As such, the seal assembly 100 includes the sump housing 102. The sump housing 102 includes at least a portion of the rotating shaft 31 and the fixed housing 39. For example, the fixed housing 39 may include various intermediary components or parts extending from the fixed housing 39 to form a portion of the sump housing 102. Such intermediary components parts may be coupled to the fixed housing 39 or formed integrally with the fixed housing 39. Similarly, the rotating shaft 31 may also include various intermediary components extending from the rotating shaft 31 to form the sump housing. Further, the sump housing 102 at least partially defines a compartment, more particularly, a bearing compartment 120 for holding a cooling lubricant (not shown). For instance, the sump housing 102 at least partially radially encloses the cooling lubricant and a bearing 118 (as described in more detail in relation to FIG. 3A). The cooling lubricant (e.g., oil) for lubricating the various components of the bearing 118 may circulate through the bearing compartment 120. The seal assembly 100 may include one or more sump seals 105 (as described in more detail in reference to FIGS. 3 and 4) at least partially defining the bearing compartment 120 for holding the cooling lubricant.

The seal assembly 100 further includes a pressurized housing 103 positioned exterior to the sump housing 102. The pressurized housing 103 may at least partially enclose the sump housing 102. For example, as illustrated, the pressurized housing 103 may be positioned both forward and aft relative to the centerline axis 12 of the turbomachine engine 10. The pressurized housing 103 may include at least a portion of the rotating shaft 31 and the fixed housing 39 or intermediary components extending from the rotating shaft 31 and/or the fixed housing 39. For example, the pressurized housing 103 may be formed at least partially by the high-pressure drive shaft 30 and the fixed housing 39 both forward and aft of the sump housing 102.

For the depicted example, the pressurized housing 103 defines a compartment, and more particularly, a pressurized compartment 124 to at least partially enclose the sump housing 102. In the exemplary example, bleed air from the compressor section 23 (FIG. 1), the turbine section 29 (FIG. 1), and/or the fan section 16 (FIG. 1) may pressurize the pressurized compartment 124 to a pressure relatively greater than the pressure of the bearing compartment 120. As such, the pressurized compartment 124 may prevent or reduce the amount of any cooling lubricant leaking from the sump housing 102 across the sump seal 105.

Further, the seal assembly 100 may include one or more seals to further partially define the pressurized compartment 124 (such as the seal assemblies 200 and 300) as described in more detail in regards to FIGS. 4-10). For instance, one or more sealing elements may be positioned between the rotating shaft 31 and the fixed housing 39.

Referring now to FIG. 3A, a closer view of the sump housing 102 is illustrated according to aspects of the present disclosure. In the illustrated example, the seal assembly 100 includes the bearing 118. The bearing 118 may be in contact with an exterior surface of the rotating shaft 31 and an interior surface of the fixed housing 39. It should be recognized that the rotating shaft 31 may be the high-pressure drive shaft 30 or the low-pressure drive shaft 34 described in regards to FIG. 1 or any other rotating drive shaft of the turbomachine 10. The bearing 118 may be positioned radially between the portion of the rotating shaft 31 and the portion of the fixed housing 39 that form the sump housing 102. As such, the bearing 118 may be positioned within the sump housing 102. The bearing 118 may support the rotating shaft 31 relative to various fixed components in the engine.

In the depicted example, the bearing 118 may be a thrust bearing. That is, the bearing 118 may support the rotating shaft 31 from loads in the axial, or the axial and radial directions relative to the centerline axis 12. For example, the bearing 118 may include an inner race 128 extending circumferentially around an outer surface of the rotating shaft 31. In the shown example, an outer race 130 is disposed radially outward from the inner race 128 and mates with the fixed housing 39, such as an interior surface of the sump housing 102. The inner and outer races 128, 130 may have a split race configuration. For the depicted example, the inner and outer race 128, 130 may sandwich at least one ball bearing 132 therebetween. Preferably, the inner and outer races 128, 130 sandwich at least three ball bearings 132 therebetween.

In additional examples, the bearing 118 may be a radial bearing. That is, the bearing 118 may support the rotating shaft 31 from loads generally in the radial direction relative to the centerline axis 12. In other examples, the inner race 128 and outer race 130 may sandwich at least one cylinder, cone, or other shaped element to form the bearing 118.

Still referring to FIG. 3A, the seal assembly may include two sump seals 105. Each of a first and second sump seals 105 may be positioned between the rotating shaft 31 and the fixed housing 39 to at least partially define the bearing compartment 120 for housing the cooling lubricant and the bearing 118. For example, the first sump seal 105 may be positioned forward of the bearing 118, and the second sump seal 105 may be positioned aft of the bearing 118. For the illustrated example, the first sump seal 105 may be a labyrinth seal 104, and the second sump seal 105 may be a carbon seal 106. Although, the two sump seals 105 may be any suitable type of seal, and, in other examples, the sealing system may include further sump seals 105, such as three or more. For example, in other examples, multiple labyrinth seals, carbon seals, and/or hydrodynamic seals may be utilized in the sump housing 102 in any arrangement.

FIG. 3A also more closely illustrates the labyrinth seal 104 and the carbon seal 106. For the example depicted, the labyrinth seal 104 and the carbon seal 106 (such as a hydrodynamic seal) are non-contact seals, which do not require contact between the stationary and moving components when operating at high speed. Non-contact seals typically have a longer service life than contact seals. Still, in other examples, one or both of the sump seals 105 may be contact seal. Each type of seal may operate in a different manner. For the depicted example, the labyrinth seal 104 includes an inner surface 136 (coupled to the rotating shaft 31) and an outer surface 138 (coupled to the fixed housing 39). For example, a tortuous path (not shown) extending between the inner surface 136 and the outer surface 138 prevents the cooling lubricant from escaping the sump housing 102. For the exemplary example shown, the air pressure on an outer side of the labyrinth seal 104 (i.e., in the pressurized compartment 124) is greater than the air pressure on the inner side of the labyrinth seal 104 (i.e., in the bearing compartment 120). In this respect, the stationary and rotating components may be separated by an air film (sometimes called an air gap) during relative rotation therebetween.

The carbon seal 106 may, in some examples, be a hydrodynamic or non-contacting seal with one or more grooves 140 that positioned between the stationary and rotating components, as illustrated in FIG. 3A. In general, the hydrodynamic grooves may act as pump to create an air film between the non-contacting carbon seal 106 and the rotating shaft 31. For example, as the rotating shaft 31 rotates, fluid shear may direct air in a radial gap 112 into the hydrodynamic groove(s). As air is directed into the hydrodynamic grooves, the air may be compressed until it exits the hydrodynamic groove(s) and forms the air film to separate the rotating shaft 31 and the non-contacting carbon seal 106. The air film may define a radial gap 112 between the stationary and non-stationary components of the seal assembly 100, as shown in FIG. 3A. Thus, the rotating shaft 31 may ride on the air film instead of contacting the inner sealing surface 108.

In some examples, the carbon seal 106 is proximate to and in sealing engagement with a hairpin member 146 of the rotating shaft 31. In this respect, the hairpin member 146 may contact the carbon seal 106 when the rotating shaft 31 is stationary or rotating at low speeds. Though it should be recognized that the carbon seal 106 may be in sealing engagement with any other part or component of the rotating shaft 31. Nevertheless, for the illustrated hydrodynamic, carbon seal 106, the carbon seal 106 lifts off of the rotating shaft 31 and/or the hairpin member 146 when the rotating shaft 31 rotates at sufficient speeds.

Referring now to FIG. 3B, a sump housing 102 of a seal assembly 100 is illustrated according to another aspect of the present disclosure. It should be noted that the description of the seal assembly 100 of FIG. 3A applies to like parts of the seal assembly 100 of FIG. 3B unless otherwise noted, and accordingly like parts will be identified with like numerals.

The sump housing 102 of FIG. 3B particularly illustrates the sump housing 102 with three sump seals 105. The sump housing 102 may generally be configured as the sump housing 102 of FIG. 3A. For example, the sump housing 102 may include a portion of the rotating shaft 31, a portion of the fixed housing 39, and enclose the bearing 118. Further, the sump seals 105 and the sump housing 102 at least partially define the bearing compartment 120.

In the example illustrated, one of the sump seals 105 is a contacting lip seal 107. As such, the inner surface 136 and the outer surface 138 may be in contact in order to seal the sump housing 102. Further, a spring 157 may be in compression between the outer surface 138 and the fixed housing 39 to maintain contact between the inner surface 136 and the outer surface 138. The illustrated example further includes a carbon seal 106 configured as a contacting carbon seal. As such, the carbon seal 106 includes a carbon element 150 in sealing engagement with the rotating shaft 31. For the example depicted, the carbon element 150 may engage the hairpin member 146 of the rotating shaft 31. Additionally, the carbon seal 106 may include a windback 152 that reduces the amount of the cooling lubricant that reaches the carbon element 150. Further, one of the sump seals 105 may be an open gap seal 110. For instance, the pressure on an outer side 154 (such as the pressurized compartment 124) may be greater than the pressure of the bearing compartment 120 and thus reduce the leakage of cooling lubricant through the open gap seal 110. In further examples, one of the sump seals 105 may be a brush seal. In such examples, the brush seal may contain a plurality of bristles (such as carbon bristles) in sealing engagement between the rotating shaft 31 and the fixed housing 39.

Another example seal assembly 200 that may be used with the turbomachine engine discussed above is illustrated in FIG. 4. It should be noted that the description of the seal assembly 100 of FIGS. 2, 3A and 3B applies to like parts of the seal assembly 200 of FIG. 4 unless otherwise noted, and accordingly like parts will be identified with like numerals.

The seal assembly 200 positioned between the components of the rotating shaft 31 and the components of the fixed housing 39 can comprise a runner 202 disposed circumferentially around and statically coupled to the rotating shaft 31 and a sealing element 204 statically coupled to a stationary member 206 of the fixed housing 39.

During the operation of a turbomachine engine 10 that includes the seal assembly 200, the rotation of the rotating shaft 31 causes the corresponding rotation of the runner 202 connected to the rotating shaft 31. The runner 202 rotates relative to the sealing element 204 along an interfacial zone 210. The interfacial zone 210 can, in some examples, form a boundary between two chambers, such as the bearing compartment 120 and the pressurized compartment 124 described above, and accordingly the interfacial zone 210 can, in some examples, prevent the flow of fluids between the two chambers.

In some examples, such as that illustrated in FIG. 4 the seal assembly 200 can be a hydrodynamic seal. In such examples, the sealing element 204 and/or the runner 202 can have hydrodynamic features such as hydrodynamic grooves 216. The hydrodynamic grooves 216 function in substantially the same way as the one or more hydrodynamic grooves 140 in non-contacting hydrodynamic carbon seal 106 described above to create an air cushion in a gap 214 between the runner 202 and the sealing element 204. As the rotating shaft 31 and the connected runner 202 rotate relative to the sealing element 204 and the fixed housing 39, the air cushion prevents the sealing element 204 and the runner 202 from coming into contact, while preventing the flow of fluids such as coolant between the two chambers separated by the seal, such as the bearing compartment 120 and the pressurized compartment 124.

Due to the high relative rotational speed between the runner 202 and the sealing element 204 along the interfacial zone 210, it may be advantageous, particularly in examples of seal assembly 200 that include a contacting seal, to select materials for the runner 202 and the sealing element 204 that both have high thermal conductivity, and which form a low coefficient of dynamic friction along the interfacial zone 210. For instance, in one particular example, the runner 202 can be formed of steel or other hard, non-deforming material, and the sealing element 204 can be formed from carbon. However, it is to be understood that other materials with high thermal conductivity and low coefficient of friction against the material of the runner 202 can be used for the sealing element 204.

Because the operation of non-contacting seals can include the formation of a pressurized air film between the portions of the seal assembly that form a rotating interface, such as the interfacial zone 210 illustrated in FIG. 4, and the corresponding formation of a seal gap, such as the gap 214 illustrated in FIG. 4, and because the hydrodynamic effect can vary based on operating conditions of the engine, such as the relative rotational speeds of the components of the seal assembly, such seal assemblies generally also include a mechanism for controlling the gap between components of the seal assembly, such as the runner 202 and the sealing element 204 previously described. However, when the gap controlling mechanism is too sensitive to rapid variations in the forces and/or operational conditions affecting the turbomachine engine and the seal assembly, a resulting rapid change in the seal gap may occur. In some instances, a sufficiently rapid change in the seal gap can cause undesirable contact between the components of the seal assembly. As such, it can be advantageous to include a damping mechanism configured to more gradually adjust the relative positioning of the components of the seal assembly and thus the width of the seal gap, as will be discussed in greater detail below.

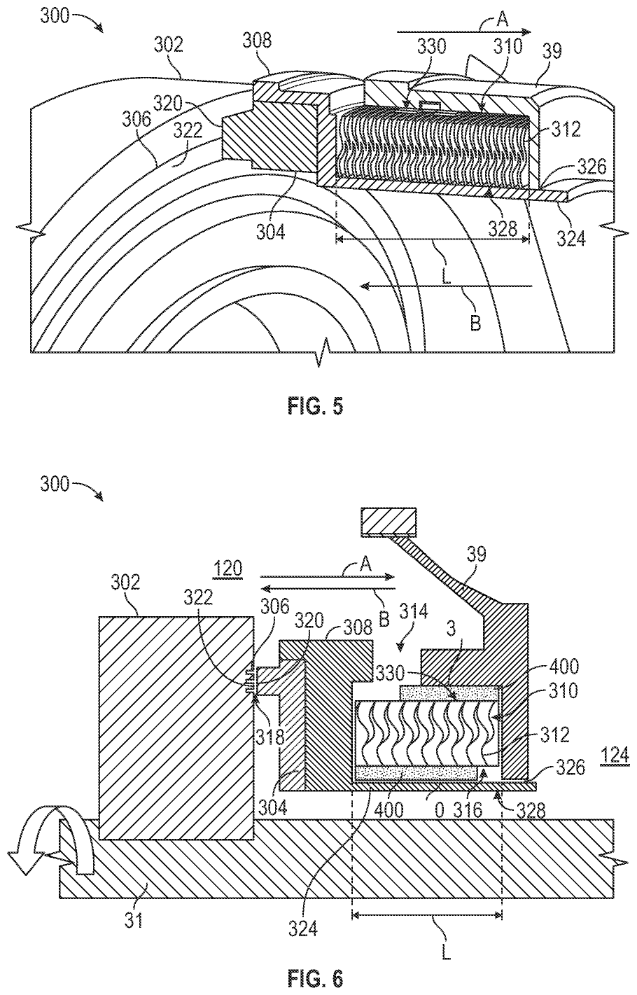

FIGS. 5 through 7 show examples of non-contacting hydrodynamic seal assemblies 300 having a damping mechanism. As can be seen in FIG. 6, the hydrodynamic seal 300 can be positioned between the bearing compartment 120 and the pressurized compartment 124 in a fashion similar or substantially identical to that previously discussed regarding seal assemblies 100 and 200. Referring again to FIGS. 5-7, the seal assembly 300 can comprise a runner 302 statically coupled to the rotating shaft 31 and a sealing element 304 statically coupled to a seal housing 308 which is operatively coupled to the fixed housing 39.

The runner 302 rotates along with the rotating shaft 31 when the turbomachine engine including seal assembly 300 (such as turbomachine engine 10) is in an operational state. Thus, when the turbomachine engine is in an operational condition, the runner 302 will rotate relative to the sealing element 304 around the axis defined by the rotating shaft 31. The runner 302 may further include one or more hydrodynamic grooves 306, as shown in FIGS. 5 through 7. As described above with relation to hydrodynamic carbon seal 106, the hydrodynamic grooves 306 can cause the formation of a pressurized air film between the runner 302 and the sealing element 304 when the turbomachine engine is in an operational state, allowing the seal assembly 300 to separate the bearing compartment 120 and the pressurized compartment 124 without the runner 302 and the sealing element 304 coming into rotational contact with each other.

The sealing element 304 is mounted to the seal housing 308, which, together with the fixed engine 39 can define a spring chamber 310. The spring chamber 310 has a length L, as indicated in FIGS. 5 and 6, and contains a spring element 312 (for example, a bellows spring, coil spring, or any other suitable spring) which extends axially between the fixed housing 39 and the seal housing 308. In some examples, the spring element 312 can be an annular spring (such as the annular bellows spring shown in FIGS. 5 and 6), disposed radially outwards from the rotating shaft 31 and radially inwards from the fixed housing 39, around the entire circumference of the seal assembly 300. In other examples, the spring element 312 can comprise a plurality of linear and/or wave springs, disposed between the seal housing 308 and the fixed housing 39, each covering a portion of the circumference of the seal assembly 300, and spaced circumferentially apart from one another around the circumference of the spring chamber 310.

As illustrated in FIG. 5, the fixed housing 39 and the seal housing 308 can define a first gap 314 and a second gap 316, opening the spring chamber 310 to the bearing compartment 120 and the pressurized compartment 124, respectively. Because the gaps 314, 316 separate the seal housing 308 from the fixed housing 39, as shown in FIG. 6, the seal housing 308 is allowed to move axially relative to the fixed housing 39, such that the length L of the spring chamber 310 can vary with any axial forces applied to the sealing element 304 and/or the seal housing 308, based on the deflection of the spring element 312 and the pressure exerted by the hydrodynamic effect between the rotating runner 302 and the sealing element 304 when the turbomachine engine is in an operational state.

For example, when the turbomachine engine is in an operational state, the formation of the pressurized air film between the runner 302 and the sealing element 304 creates a seal gap 318, which tends to apply a force in a first axial direction to push the sealing element 304 away from the runner 302. Specifically, the pressurized air film created by the hydrodynamic grooves 306 applies an axially-oriented hydrodynamic force in the direction indicated by arrow A in FIG. 6 on the sealing element 304. The axially oriented hydrodynamic force exerted by the pressurized air film pushes the sealing element 304 away from the runner 302 to form the seal gap 318. The axially directed force of the pressurized air film tends also to press the seal housing 308 towards the fixed housing 39, causing the length L of the spring chamber 310 to decrease as the spring chamber 310 axially shortens under axial force. In turn, this compresses the spring element 312 until the reactive force exerted by the spring element 312 in a second axial direction opposite to the first axial direction (i.e., tending to push the seal housing 308 away from the fixed housing 39 and the sealing element 304 towards the runner 302) counterbalances the axial force applied by the pressurized air film to the sealing element 304 and/or the seal housing 308. In this way, the width of the seal gap 318 can be varied depending on the rotational speed of the rotating shaft 31 when the turbomachine engine is in an operational state and can also be varied to accommodate physical shocks or disturbances to the turbomachine engine.

However, in some instances, changes in the rotational speed of the rotating shaft 31 and/or physical shocks or disturbances to the turbomachine engine can cause the axially-oriented forces in the directions indicated by arrows A and B to vary too rapidly, causing drastic fluctuations in the width of the seal gap 318, and unintentional contact between a first surface 320 of the sealing element 304 and a first surface 322 of the runner 302. This can cause the runner 302 to abrade or otherwise damage the sealing element 304, which over the lifetime of the sealing element 304 can cause the first surface 320 of the sealing element 304 to develop angled, planed, or conical geometries. In turn, this can cause the first surface 320 of the sealing element 304 to lose conformity with the corresponding first surface 322 of the runner 302, which can cause undesirable variations in the width of the seal gap 318, loss of the hydrodynamic effect of the seal assembly 300, and, over time, loss of functionality of the seal assembly 300.

To counteract this, a damping mechanism can be added to the spring element 312 and the spring chamber 310 of the seal assembly 300. As shown in FIGS. 5 and 6, the seal assembly 300 includes a sealing member 324 as a damping element to partially block the second gap 316, leaving an aperture 326 between the seal housing 308 and the fixed housing 39. The sealing member 324 leaves a first side 328 of the spring chamber 310 open to the pressurized compartment 124 only at the aperture 326. The aperture 326 allows air to pass between the spring chamber 310 and the pressurized compartment 124 at a controlled rate. Because any axial expansion or axial compression of the spring chamber 310 also respectively increases or decreases the volume of the spring chamber 310 while the aperture 326 controls and limits the rate of flow of air between the pressurized compartment 124 and the spring chamber 310, the pressure of the air inside the spring chamber 310 also changes. This can create a pressure differential that can slow the relative motion of the seal housing 308 and the fixed housing 39, until air is able to pass between the pressurized compartment 124 and the spring chamber 310.

In some examples, such as that illustrated in FIG. 6, the spring chamber 310 is also open to the bearing compartment 120 along a second side 330 of the spring chamber 310. Because the bearing compartment 120 typically contains a lubricant and/or coolant, some portion of the lubricant and/or coolant can enter the spring chamber 310 along the second side 330 of the spring chamber 310 and fill the portions of the spring chamber 310 open to the bearing compartment 120. The presence of a substantially incompressible fluid in the spring chamber 310 can tend to resist the compression and/or expansion of the spring chamber 310 during the operation of the turbomachine engine as described above. In this way, the damping effect achieved by controlling the flow of air between the first side 328 of the spring chamber 310 can be augmented by hydraulic damping achieved by the fluid in the second side 330 of the spring chamber 310.

As illustrated in FIG. 6, the damping of the motion of the components of the seal assembly 300, such as the sealing element 304 and the seal housing 308 relative to the fixed housing 39 and the runner 302, can be achieved by including a foil damper 400 in the spring chamber 310 as the damping element.

The foil damper 400, best shown in detail in FIG. 8, can comprise an outer sheath 402 and an inner sheath 404. A corrugated foil 406 can be disposed between the outer sheath 402 and the inner sheath 404 of the foil damper 400. The corrugated foil 406 can attach at a first end 408 to the outer sheath 402 and at a second end 410 to the inner sheath 404. The foil damper 400 can be configured such that the outer sheath 402 and the inner sheath 404 of the foil damper 400 can be configured to move axially relative to one another. As the outer sheath 402 and the inner sheath 404 of the foil damper move axially relative to each other, the first end 408 of the corrugated foil 406 can move along with the outer sheath 402 and the second end 410 of the corrugated foil 406 can move along with the inner sheath 404 of the foil damper. The corrugated foil 406 elastically deforms or axially moves to accommodate the relative axial motion of the outer sheath 402 and the inner sheath 404, and the force required to cause this elastic deformation or axial motion of the corrugated foil resists the forces moving the outer sheath 402 and the inner sheath 404.

As shown in FIG. 6, the spring chamber 310 can contain one or more foil dampers 400. In some examples, the foil dampers 400 can be disposed radially inward of the spring element 312, with the outer sheath 402 of the foil damper 400 contacting an exterior surface of the spring element 312 and the inner sheath 404 of the foil damper 400 disposed along a first wall 340 of the spring chamber 310 formed by the seal housing 308. As the seal housing 308 and the fixed housing 39 move closer to or further apart from each other (i.e., as the seal gap 318 expands or contracts), the inner sheath 404 of the foil damper 400 moves along with the seal housing 308, and the deformation and/or axial movement of the corrugated foil 406 provides a reactive force that partially resists the movement of the inner sheath 404 of the foil damper 400 relative to the outer sheath 402 of the foil damper 400 and thus slows the axial expansion or axial compression of the spring chamber 310 and the corresponding expansion or contraction of the seal gap 318 and prevents any sudden movement that may cause undesired contact between the sealing element 304 and the runner 302.

In other examples, the foil dampers 400 can be disposed radially outward of the spring element 312, with the inner sheath 404 of the foil damper 400 contacting an exterior surface of the spring element 312 and the outer sheath 402 of the foil damper 400 contacting a second wall 342 of the spring chamber 310 formed by the fixed housing 39. As the seal housing 308 and the fixed housing 39 move closer to or further apart from each other (i.e., as the seal gap 318 expands or contracts), the inner sheath 404 of the foil damper 400 moves along with the spring element 312 as it expands or compresses, while the outer sheath 402 of the foil damper 400 remains fixed to the second wall 342 of the spring chamber 310. The deformation and/or axial movement of the corrugated foil 406 provides a reactive force partially resists the movement of the inner sheath 404 of the foil damper 400 relative to the outer sheath 402 of the foil damper 400 and thus slows the axial expansion or compression of the spring chamber 310 and the corresponding expansion or contraction of the seal gap 318 and prevents any sudden movement that may cause undesired contact between the sealing element 304 and the runner 302.

In some examples, such as that shown in FIG. 6, the seal assembly 300 can include a first foil damper 400 disposed radially inward of the spring element 312, and a second foil damper 400 disposed radially outward of the spring element 312.

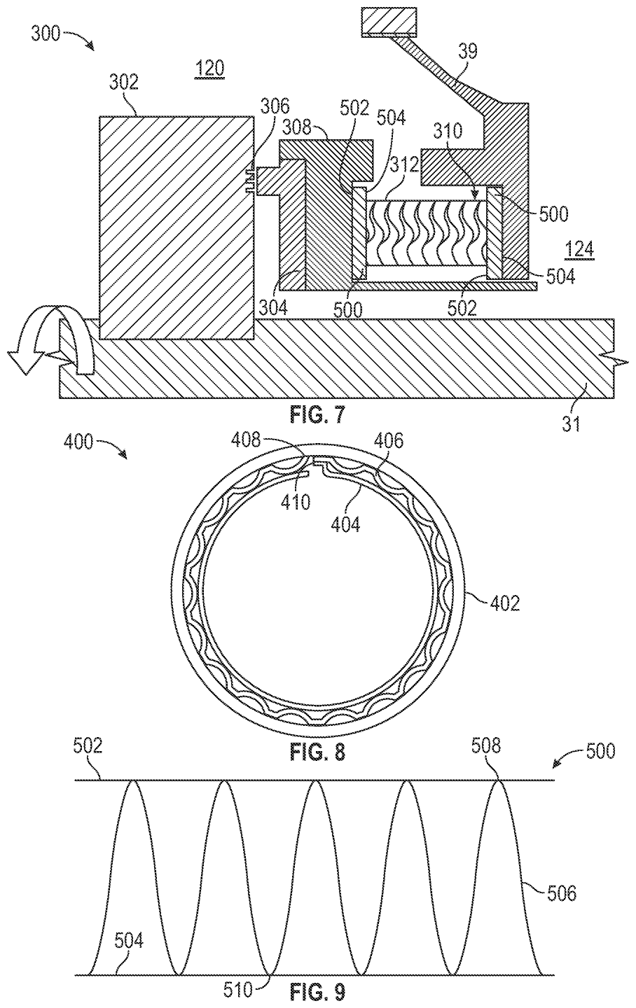

In another example, as shown in FIG. 7, the damping of the motion of the components of the seal assembly 300 such as the sealing element 304 and the seal housing 308 relative to the fixed housing 39 and the runner 302 can be achieved by including a wave spring 500 in the spring chamber 310 as the damping element.

As illustrated in FIG. 9 the wave spring 500 can comprise a first face 502 and a second face 504. A wave form member 506 extends between the first face 502 and the second face 504. The wave form member 506 has a plurality of first apices 508 and a plurality of second apices 510, with the first apices 508 contacting the first face 502 of the wave spring 500 and the second apices 510 contacting the second face 504 of the wave spring 500.

Returning now to FIG. 7, the wave spring 500 can be included in the spring chamber 310 to slow the axial movement of the seal housing 308 relative to the fixed housing 39 and the runner 302. For example, the wave spring 500 can be positioned between the spring element 312 and the seal housing 308 as shown in FIG. 7, such that the first face 502 of the wave spring 500 contacts the seal housing 308 and the second face 504 of the wave spring 500 contacts the spring element 312. In other examples, the wave spring 500 can also be positioned between the spring element 312 and the fixed housing 39, such that the first face 502 of the wave spring 500 contacts the spring element 312 and the second face 504 of the wave spring 500 contacts the fixed housing. While FIG. 7 depicts a seal assembly having two wave springs 500, one positioned on either end of the spring element 312, it is to be understood that, in other examples, only one wave spring 500 can be included, either between the seal housing 308 and the spring element 312 or between the spring element 312 and the fixed housing 39.

When changes in the pressure applied to the sealing element 304 and the seal housing 308 by the pressurized hydrodynamic air film, shocks, and/or impacts to the turbomachine cause an abrupt axial movement of the seal housing 308 relative to the runner 302 and the fixed housing 39, the wave spring 500 can apply a resistive force to oppose and slow the axial movement of the seal housing 308 relative to the runner 302 and the fixed housing 39. Specifically, when the seal housing 308 moves away from the runner 302 and towards the fixed housing 39, the wave spring 500 can compress along with the spring element 312, adding resistance to the compression of the spring chamber 310 and causing the seal gap 318 to come to an equilibrium width more gradually. When the seal housing 308 moves towards the runner 302 and away from the fixed housing 39, the decompression of the wave spring 500 can happen gradually, and may tend to resist the motion of the seal housing 308, causing the seal gap 318 to come to an equilibrium width more gradually.

In this way, the movement of the seal housing 308 relative to the runner 302 and the fixed housing 39 can be slowed, and the changes in the width of the seal gap 318 can be made more gradual. This in turn can mitigate the tendency of abrupt changes in the seal gap 318 to cause the sealing element 304 to unintentionally come in contact with the runner 302 with abrupt changes in the pressure caused by the hydrodynamic air film, and thus prevent wear, planing, and/or coning of the sealing element 304 over the lifetime of the engine's operation.

The spring elements, spring chambers, foil dampers, and wave spring dampers disclosed herein can be formed of any suitable material with an appropriate stiffness for absorbing the varying forces imparted to the sealing element 304 and the seal housing 308 by the pressurized hydrodynamic air film. In some examples, any or all of these components can be formed from a shape memory material, such as a bi-metallic material or a shape memory alloy, which may advantageously help to attenuate undesirable vibrations in the components of the seal assembly 300.

It is to be understood that any of spring elements, spring chambers, foil dampers, and wave spring dampers previously mentioned to slow the motion of the seal housing 308 relative to the runner 302 and the fixed housing 39 can be used alone or in conjunction. In other words, the seal housing 308 can be damped by pneumatic or hydraulic effects, foil dampers, wave spring dampers, or any combination thereof.

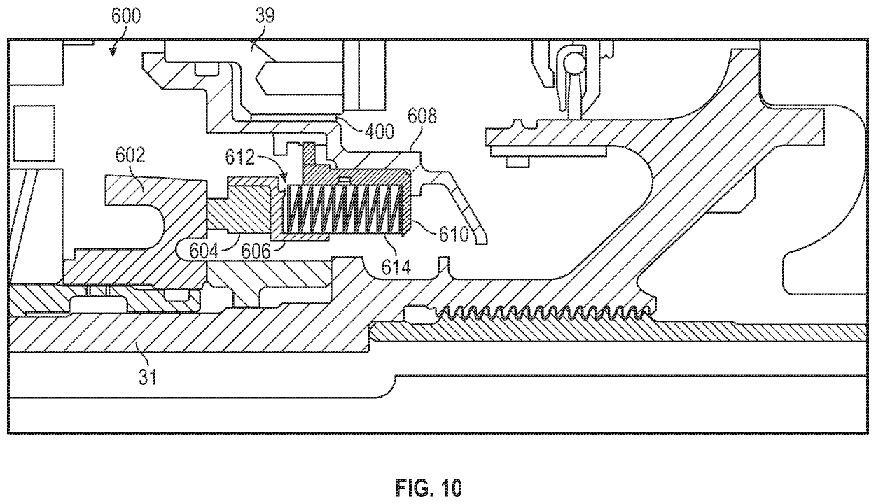

In another example, illustrated in FIG. 10, the turbomachine engine can include a vibration damper such as the foil damper 400 previously described disposed within the fixed housing 39 to absorb vibrations. As shown in FIG. 10, a turbomachine engine 600 can include a rotating shaft 31 and a fixed housing 39. A runner 602 can be statically attached to the rotating shaft 31, and rotates along with the rotating shaft 31 when the turbomachine engine 600 is in an operational state. A sealing element 604 can be in operational or hydrodynamic contact with the runner 602, and can be mounted to a seal housing 606. A hanging carrier 608 can be operatively coupled to the fixed housing 39, extending radially inwards from the fixed housing 39 and supporting a spring housing 610.

As illustrated in FIG. 10, the seal housing 606 and the spring housing 610 define a spring chamber 612, and a spring 614 can be disposed within the spring chamber to control the contact and/or spacing of the hydrodynamic gap between the sealing element 604 and the runner 602 as described in greater detail above.

A vibration damper, such as foil damper 400 can be disposed between the fixed housing 39 and the hanging carrier 608, radially outwards from the hanging carrier 608 and radially inwards from the fixed housing 39. The foil damper 400 can absorb vibration arising from engine operations, turbulence, and/or physical shocks to the turbomachine engine 600, controlling the spacing between the hanging carrier 608 and the fixed housing 39 and preventing minor changes in the spacing due to vibration while the turbomachine engine 600 is in an operational condition in a manner substantially identical to that discussed above in relation to the foil dampers 400 shown in FIG. 7.

The various examples described above can offer improved control over the gap between the various components of the seal assemblies for turbomachines, particularly those components which rotate relative to one another. By improving control over the gap between these components, the risk of undesirable contact between the components, particularly while the turbomachine is in an operational state, is thereby reduced. This in turn may reduce the incident of rubs and abrasion that can damage the seal interface and/or can impair the function of the seal assembly. The performance and expected lifecycle of the seal assemblies may thereby be improved.

In view of the many possible embodiments to which the principles of the disclosure may be applied, it should be recognized that the illustrated embodiments are only preferred examples of the disclosure and should not be taken as limiting the scope of the disclosure. Rather, the scope of the disclosure is defined by the following claims.

Further aspects of the disclosure are provided by the subject matter of the following clauses:

A seal assembly for a turbomachine, the turbomachine including a rotating shaft extending along a centerline axis and a fixed housing positioned exterior to the rotating shaft in a radial direction relative to the centerline axis, the seal assembly comprising a runner statically coupled to the rotating shaft, a sealing element positioned between the runner and the fixed housing and moveable relative to the fixed housing the direction of the centerline axis, a spring chamber disposed between the sealing element and the fixed housing, a spring element disposed within the spring chamber, and a damping element; wherein the runner rotates along with the rotating shaft and relative to the sealing element when the turbomachine is in an operational condition, wherein the seal assembly separates a first compartment from a second compartment and wherein the chamber is open to the first compartment along a first opening, wherein the spring element allows the sealing element to move relative to the runner and the fixed housing, and to control the width of a seal gap between the runner and the sealing element, and wherein the damping element slows movement of the sealing element relative to the runner and the fixed housing.

The seal assembly of any preceding clause, wherein the sealing element and the runner comprise a non-contacting seal.

The seal assembly of any preceding clause, wherein at least one of the sealing element or the runner comprise a hydrodynamic groove.

The seal assembly of any preceding clause, wherein the damping element is a sealing member partially occluding the first opening to form an aperture that partially restricts a flow of air between the spring chamber and the first compartment.

The seal assembly of any preceding clause, wherein the spring chamber is open to the second compartment along a second opening, and wherein a fluid from the second compartment is admitted to the spring chamber through the second opening.

The seal assembly of any preceding clause, wherein the damping element is a foil damper disposed within the spring chamber.

The seal assembly of any preceding clause, wherein the foil damper is annular and disposed around the circumference of the spring chamber.

The seal assembly of any preceding clause, wherein the foil damper is disposed radially inward from the spring element.

The seal assembly of any preceding clause, wherein the foil damper is disposed radially outwards from the spring element.

The seal assembly of any preceding clause, wherein the damping element is a wave spring disposed in the spring chamber, axially in line with the spring element.

The seal assembly of any preceding clause, wherein the spring element is a bellows spring.

The seal assembly of any preceding clause, wherein at least one of the spring element or the damping element comprises a shape memory alloy.

A turbomachine, comprising a rotating shaft extending along a centerline axis and a fixed housing positioned exterior to the rotating shaft in a radial direction relative to the centerline axis and a seal assembly comprising a runner statically coupled to the rotating shaft, a sealing element statically coupled to a seal housing, a spring chamber defined by the fixed housing and the seal housing, a spring element disposed within the chamber and an aperture between the spring chamber and a first compartment of the fixed housing; wherein the seal housing is movable relative to the runner and to the fixed housing, wherein the spring chamber axially expands and axially compresses as the seal housing moves relative to the runner and the fixed housing, wherein when the turbomachine is in an operational state, a seal gap exists between the sealing element and the runner, and the width of the seal gap is controlled by the spring element; and wherein the aperture in the chamber allows air to pass between the chamber and the first compartment of the fixed housing at a controlled rate and to slow the axial expansion and axial compression of the spring element disposed within the chamber.

The seal assembly of any preceding clause, wherein the runner further comprises one or more hydrodynamic grooves.

The seal assembly of any preceding clause, wherein the sealing element further comprises one or more hydrodynamic grooves.

The seal assembly of any preceding clause, further comprising a foil damper disposed within the spring chamber.

The seal assembly of any preceding clause, further comprising a wave spring damper disposed within the spring chamber.

The seal assembly of any preceding clause, wherein the spring element is a bellows spring.

The seal assembly of any preceding clause, wherein the bellows spring comprises a shape memory alloy.

The seal assembly of any preceding clause, wherein the fluid slows the movement of the sealing element relative to the runner and the fixed housing.

The seal assembly of any preceding clause wherein the seal assembly is included in a sump seal of a turbomachine engine.

The seal assembly of any preceding clause wherein the seal assembly is included in a labyrinth seal of a turbomachine engine.

The seal assembly of any preceding clause wherein the seal assembly is included in an aspirating face seal of a turbomachine engine.

The seal assembly of any preceding clause wherein the seal assembly further comprises a windback that reduces the flow of lubricant between the runner and the sealing element.

An engine housing for a turbomachine, the turbomachine including a rotating shaft extending along a centerline axis and the engine housing comprising a fixed housing; a hanging carrier disposed radially inward from the fixed housing; and a vibration damper extending from the hanging carrier to the fixed housing; wherein the engine housing is positioned exterior to the rotating shaft in a radial direction relative to the centerline axis; and wherein the vibration damper reduces motion of the hanging carrier relative to the fixed housing when the engine is in an operational state.

The engine housing of any preceding clause, wherein the vibration damper is a foil damper disposed circumferentially around the centerline axis.

1. A seal assembly for a turbomachine, the turbomachine including a rotating shaft extending along a centerline axis and a fixed housing positioned exterior to the rotating shaft in a radial direction relative to the centerline axis, the seal assembly comprising:
a runner statically coupled to the rotating shaft;
a sealing element positioned between the runner and the fixed housing and movable relative to the fixed housing in the direction of the centerline axis;
a spring chamber disposed between the sealing element and the fixed housing;
a spring element disposed within the spring chamber; and
a damping element;
wherein the runner rotates along with the rotating shaft and relative to the sealing element when the turbomachine is in an operational condition,
wherein the seal assembly separates a first compartment from a second compartment and wherein the spring chamber is open to the first compartment along a first opening;
wherein the spring element allows the sealing element to move relative to the runner and the fixed housing, and to control the width of a seal gap between the runner and the sealing element; and
wherein the damping element slows movement of the sealing element relative to the runner and the fixed housing.

2. The seal assembly of claim 1, wherein the sealing element and the runner comprise a non-contacting seal.

3. The seal assembly of claim 2, wherein at least one of the sealing element or the runner comprise a hydrodynamic groove.

4. The seal assembly of claim 1, wherein the damping element is a sealing member partially occluding the first opening to form an aperture that partially restricts a flow of air between the spring chamber and the first compartment.

5. The seal assembly of claim 1, wherein the spring chamber is open to the second compartment along a second opening, and wherein a fluid from the second compartment is admitted to the spring chamber through the second opening.

6. The seal assembly of claim 1, wherein the damping element is a foil damper disposed within the spring chamber.

7. The seal assembly of claim 6, wherein the foil is annular and disposed around a circumference of the spring chamber.

8. The seal assembly of claim 6, wherein the damping element is disposed radially inward from the spring element.

9. The seal assembly of claim 6, wherein the damping element is disposed radially outwards from the spring element.

10. The seal assembly of claim 1, wherein the damping element is a wave spring disposed in the spring chamber, axially in line with the spring element.

11. The seal assembly of claim 1, wherein the spring element is a bellows spring.

12. The seal assembly of claim 1, wherein at least one of the spring element or the damping element comprises a shape memory material.

13. A turbomachine, comprising:
a rotating shaft extending along a centerline axis and a fixed housing positioned exterior to the rotating shaft in a radial direction relative to the centerline axis; and
a seal assembly comprising a runner statically coupled to the rotating shaft, a sealing element statically coupled to a seal housing, a spring chamber defined by the fixed housing and the seal housing, a spring element disposed within the spring chamber and an aperture between the spring chamber and a first compartment of the fixed housing;
wherein the seal housing is movable relative to the runner and to the fixed housing;
wherein the spring chamber axially expands and axially compresses as the seal housing moves relative to the runner and the fixed housing;
wherein when the turbomachine is in an operational state, a seal gap exists between the sealing element and the runner, and the width of the seal gap is controlled by the spring element; and
wherein the aperture in the spring chamber allows air to pass between the spring chamber and the first compartment of the fixed housing at a controlled rate and to slow the axial expansion and axial compression of the spring element disposed within the spring chamber.

14. The seal assembly of claim 13, wherein the runner further comprises one or more hydrodynamic grooves.

15. The seal assembly of claim 13, wherein the sealing element further comprises one or more hydrodynamic grooves.

16. The seal assembly of claim 13, further comprising a foil damper disposed within the spring chamber.

17. The seal assembly of claim 13, further comprising a wave spring damper disposed within the spring chamber.

18. The seal assembly of claim 13, wherein the spring element is a bellows spring.

19. An engine housing for a turbomachine, the turbomachine including a rotating shaft extending along a centerline axis, the engine housing comprising:
a fixed housing;
a hanging carrier disposed radially inward from the fixed housing; and
a vibration damper extending from the hanging carrier to the fixed housing;
wherein the engine housing is positioned exterior to the rotating shaft in a radial direction relative to the centerline axis; and
wherein the vibration damper reduces motion of the hanging carrier relative to the fixed housing when the engine is in an operational state.

20. The engine housing of claim 19, wherein the vibration damper is a foil damper disposed circumferentially around the centerline axis.
